(19) United States
(12) Patent Application Publication
(10) Pub. No.: US 2026/0072674 A1
(43) Pub. Date: Mar. 12, 2026

(54) DATA PROCESSING METHOD, ELECTRONIC DEVICE, AND NON-TRANSITORY STORAGE MEDIUM

(71) Applicant: Beijing Zitiao Network Technology Co., Ltd., Beijing (CN)

(72) Inventors: Haochun LIAO, Beijing (CN); Binkai ZHANG, Beijing (CN); Xiao WANG, Beijing (CN); Yuehan DU, Beijing (CN)

(21) Appl. No.: 19/323,308

(22) Filed: Sep. 9, 2025

(30) Foreign Application Priority Data
Sep. 9, 2024 (CN) 202411261730.7

(51) Int. Cl. G06F 8/65

(52) U.S. Cl. CPC G06F 8/65

(57) ABSTRACT

Embodiments of the present disclosure provide a data processing method, an electronic device, and a non-transitory storage medium, and relate to the technical field of computer application. The data processing method includes: in response to an update setting request for first table data, displaying an update setting interface, in which the update setting interface includes a start-stop configuration item, the start-stop configuration item is configured to configure a start-stop state of an automatic update mode of the first table data, the start-stop state includes an enabled state and a disabled state; receiving, by the update setting interface, a start-stop configuration operation for the start-stop configuration item, and determining the start-stop state of the automatic update mode of the first table data according to the start-stop configuration operation.

### CROSS-REFERENCE TO RELATED APPLICATIONS

This application claims the priority to and benefits of the Chinese Patent Application, No. 202411261730.7, which was filed on Sep. 9, 2024, the aforementioned patent application is hereby incorporated by reference in its entirety.

### TECHNICAL FIELD

Embodiments of the present disclosure relate to a data processing method, an electronic device, and a non-transitory storage medium.

### BACKGROUND

Table data is widely used in many application scenarios because of its characteristics of, such as, being structured, easy to understand, flexible, strong compatibility, supporting for complex data processing and intuitive data presentation. In the practical application of table data, the timeliness and accuracy of the table data are often ensured by updating the table data.

In the related art, table data is mostly updated by manual update, which is cumbersome, time-consuming and labor-intensive in a scenario in which batch cells needs to be updated, resulting in low data update efficiency. Moreover, in response to relying on manual update and the update being not timely or omitted, erroneous data may be leaded to accumulated, which affects the accuracy of the overall data.

### SUMMARY

The present disclosure provides a data processing method, an electronic device, and a non-transitory storage medium, so as to realize automatic and timely update of a table and flexible setting of a start-stop state of an automatic update.

In a first aspect, the embodiments of the present disclosure provide a data processing method, the method includes:
in response to an update setting request for first table data, displaying an update setting interface, in which the update setting interface includes a start-stop configuration item, the start-stop configuration item is configured to configure a start-stop state of an automatic update mode of the first table data, the start-stop state includes an enabled state and a disabled state;
receiving, by the update setting interface, a start-stop configuration operation for the start-stop configuration item, and determining the start-stop state of the automatic update mode of the first table data according to the start-stop configuration operation.

In a second aspect, the embodiments of the present disclosure further provide an electronic device, the electronic device includes:
one or more processors;
a storage apparatus, configured to store one or more programs,
in response to that the one or more programs are executed by the one or more processors, the one or more processors are caused to implement the data processing method of any one of the embodiments of the present disclosure.

In a third aspect, the embodiments of the present disclosure further provide a non-transitory storage medium, the non-transitory storage medium includes a computer-executable instruction, the computer-executable instruction, in response to being executed by a computer processor, is configured to execute the data processing method of any one of the embodiments of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1A is a schematic flow diagram of a data processing method provided by an embodiment of the present disclosure.

FIG. 1B is a schematic diagram of an update setting interface for the data processing method according to an embodiment of the present disclosure provided by an embodiment of the present disclosure;

FIG. 2 is a schematic flow diagram of another data processing method provided by an embodiment of the present disclosure.

FIG. 3 is a schematic flow diagram of another data processing method provided by an embodiment of the present disclosure.

FIG. 4 is a schematic structural diagram of a data processing apparatus provided by an embodiment of the present disclosure.

FIG. 5 is a schematic structural diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged among multiple devices in the embodiment of the present disclosure are only used for illustrative purposes, and are not used to limit the scope of these messages or information.

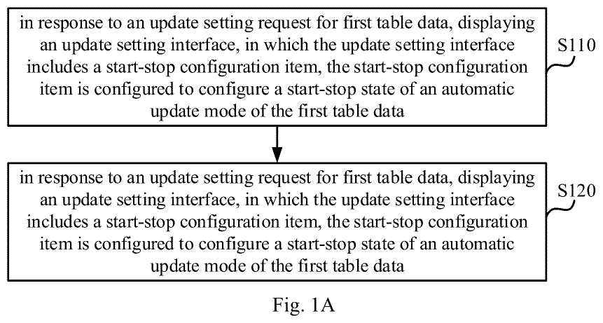

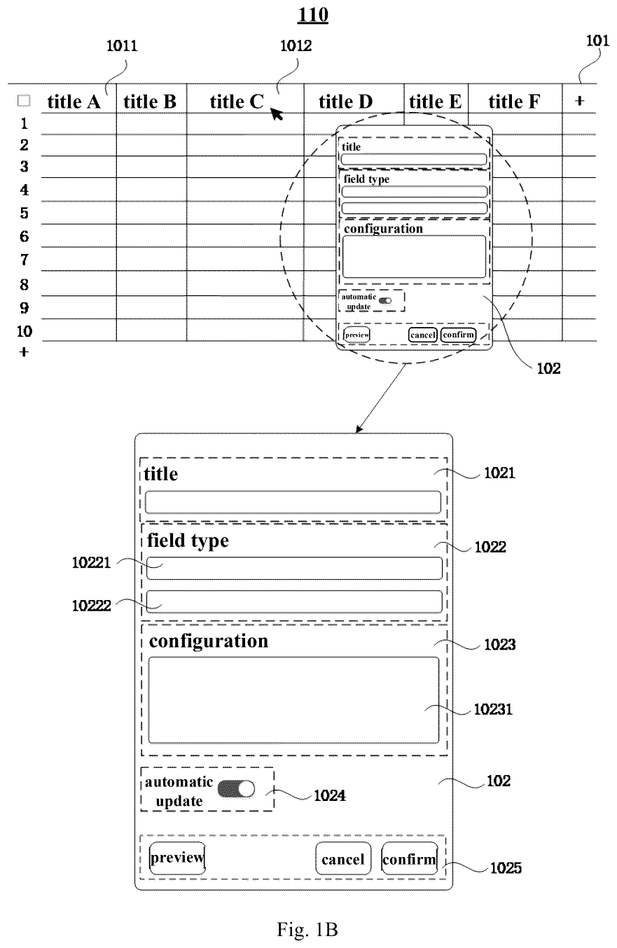

FIG. 1A is a schematic flow diagram of a data processing method provided by an embodiment of the present disclosure. The embodiments of the present disclosure are applicable to the situation where table data is automatically updated. The method may be executed by a data processing apparatus, the apparatus may be implemented in the form of software and/or hardware, or optionally, by an electronic device, and the electronic device may be a mobile terminal, a PC, a server, or the like. As shown in FIG. 1A, the method of the present embodiment may specifically include:

S110, in response to an update setting request for first table data, displaying an update setting interface, in which the update setting interface includes a start-stop configuration item, the start-stop configuration item is configured to configure a start-stop state of an automatic update mode of the first table data.

In an embodiment of the present disclosure, the first table data may be data in one or more cell in the target table. For example, the first table data may be a column of data in the target table. The target table may be understood as a table that receives an update setting request, or a table that includes the first table data. The update setting request may be understood as a request to set data update information of the first table data. The data update information may be understood as information associated with data update of the first table data. Exemplarily, the data update information may include at least one information selected from a group of a data update rule, a data update mode, and a data generation method, and combinations thereof. The data update rule may be understood as a rule followed by the first table data during update. The data update mode may be understood as a mode adopted for data updating of the first table data, such as an automatic update mode or a manual update mode. The data generation method may be understood as a generation method of updated data of the first table data, and may be obtained by processing based on a preset data arithmetic logic or generated based on data generation model, for example. The data generation model can be understood as deep learning model for automatically generating output data according to input data. For example, the data generation model may be at least one deep learning-based generation model that performs operations selected from a group of data classification, text generation text, language conversion, text generation graph, graph generation text, and combinations thereof. The deep learning-based generation model may be at least one selected from a group of a diffusion model, a style-based generation confrontation model, and combination thereof.

The update setting interface may be understood as an interface for setting data update information of the first table data. The update setting interface includes one or more information setting items for setting the data update information of the first table data. The update setting interface includes at least a start-stop configuration item. Exemplarily, the start-stop configuration item may include an update mode identification field (e.g., an automatic update mode) and an attribute value edit control corresponding to the update mode field. The attribute value edit control is configured to set whether the automatic update mode is enabled for the first table data. Whether to automatically update the first table data may be determined based on an attribute value of the attribute value edit control.

Further, the update setting interface may further include a rule configuration item. The rule configuration item is configured to configure a data update rule of the first table data. In other words, the rule configuration item may be understood as an information item for configuring a generation rule of the first table data. That is, the generation rule of the first table data may be configured by the rule configuration item.

As an optional implementation of the embodiment of the present disclosure, the rule configuration item may include a logical configuration item. The logic configuration item may be configured to configure corresponding mathematical operation logic for generating the first table data.

As another optional implementation of the embodiment of the present disclosure, the rule configuration item may include a model configuration item. The model configuration item is configured to configure model associated information corresponding to an adopted data generation model. The model associated information includes a data generation method, model input information, model output information, and the like. The model input information may specifically include a model prompt word and model input content (for example, content for being processed into model output data). The model prompt word is configured to prompt at least one selected from a group of a method by which the data generation model generates data, expected output content of the data generation model, and combination thereof. For example, the model input content may be the moon, the model prompt word may be writing a poem (that is, for prompting the method by which the data generation model generates data), and the moon (that is, the theme of the written poem, for prompting the expected output content of the data generation model), the expected output content may be writing a graceful style poem by using the model input content.

For example, the automatic update mode may be understood as a mode, after being enabled, in which preforming data update for the first table data automatically when a preset update condition is satisfied. In order to flexibly set whether or not the first table data adopts the automatic update mode, the start-stop state of the automatic update mode of the first table data can be configured by the start-stop configuration item of the update setting interface. For example, the start-stop state includes an enabled state and a disabled state. That is, in a state where the automatic update mode is enabled, in response to that the preset update condition is satisfied, the data update for the first table data is automatically performed. In a state where the automatic update mode is not enabled, the data update for the first table data is not automatically performed even if it is detected that the preset update condition is reached. For example, update inquiry information, unupdated prompt information, or the like may be displayed. The update inquiry information is configured to inquire whether to perform automatic update. In response to an update confirmation operation for the update inquiry information, an automatic update mode of the first table data is adjusted to the enabled state. The advantage of this setting is that in response to that the first table data needs to be automatically updated, the automatic update mode can be quickly and conveniently turned on, an interactive operation can be simplified, and use experience of the automatic update mode can be improved.

In an embodiment of the present disclosure, optionally, the update setting interface further includes an update preview control, and after the display of the update setting interface, the data processing method further includes: when a plurality of pieces of first table data that the start-stop configuration operation acts, displaying update preview data in at least a partial number of the plurality of pieces of first table data in response to a control trigger operation for the update preview control. By adopting this technical solution, it is possible to preview the updated data of at least a partial number of the plurality of pieces of the first table data, and to quickly determine whether the updated setting information of the updated setting interface satisfies the expectation by updating the preview data, so that when the updated setting information does not satisfy the expectation, the updated setting information can be adjusted conveniently, quickly and timely.

The control trigger operation for the update preview control may be a click operation on the update preview control. Displaying the update preview data in at least a partial number of the plurality of pieces of the first table data may be, displaying a selectable region of a target table in response to a control trigger operation for the update preview control; and in response to a region selection operation for a selectable region of the target table, displaying the update preview data in the first table data in a selected region; alternatively, in response to the control trigger operation for the update preview control and a table selection operation for the first table data, displaying the update preview data in the selected first table data; alternatively, when the number of the plurality of pieces of first table data is less than or equal to a preset number, displaying the update preview data in all of the first table data, and when the number of the plurality of pieces of first table data is larger than the preset number, displaying the update preview data in pieces of table data of preset number. The preset number may be set as needed and is not specifically limited herein, for example, 5 rows or the like.

Considering that there is a large number of pieces of table data in the target table, in order to intuitively understand the table data corresponding to the update setting information in the update setting interface, the update setting interface may further include a title corresponding to the first table data. The table data corresponding to the update setting information in the update setting interface can be quickly known through title information.

S120: receiving, by the update setting interface, a start-stop configuration operation for the start-stop configuration item, and determining the start-stop state of the automatic update mode of the first table data according to the start-stop configuration operation.

The start-stop configuration operation can be understood as an operation of setting the attribute value corresponding to the start-stop configuration item. For example, the attribute value corresponding to the start-stop configuration operation may be set to a preset value, or the attribute value corresponding to the start-stop configuration operation may be adjusted to a preset location, or the like.

Receiving, by the update setting interface, the start-stop configuration operation for the start-stop configuration item, it can be understood that, the attribute value of the start-stop configuration item may be set in the update setting interface so that the automatic update mode of the first table data presents an enabled state (for example, a turn-on state) or a disabled state (for example, a turn-off state), and further, whether the first table data is automatically updated is determined according to the attribute value set for the start-stop configuration item, and a customized setting of the automatic update of the first table data is realized.

As shown in FIG. 1B, in the target table 110 displayed in the first interface, a plurality of columns of table data may be included, and the table data of different columns may be distinguished by titles, such as title A, title B, title C, title D, title E, and title F shown in the figure. When the update setting request for the cell 1012 corresponding to the title C is received, the update setting interface 102 corresponding to a column of table data corresponding to the title C may be displayed in the form of pop-up window in the first interface.

The update setting interface 102 may include a title configuration item 1021 for determining a correspondence relationship between the update setting information and the configured table data in the update setting interface 102. In the embodiment of the present disclosure, in response to the title configuration operation for the title configuration item 1021, the correspondence relationship between the update setting information and the table data in the update setting interface 102 may be updated. In other words, the title configuration operation for the title configuration item 1021 may be received through the first interface, and the update setting information in the update setting interface 102 may be applied to the table data corresponding to the configured title.

The update setting interface 102 may include the field type setting item 1022 and the rule setting item 1023, or may include only the rule setting item 1023. The field type setting item 1022 can be understood as a configuration item for the data generation mode in the rule setting item, and may be, for example, a model configuration item. The model configuration item, for example, includes a first format configuration item 10221 for setting data output by the model and a configuration item 10222 for the data generation mode corresponding to the adopted data generation model. The rule setting item 1023 may include a rule input region 10231, and may further include a second format configuration item for setting the format of the updated data. Exemplarily, a data update rule for the cell 1012 corresponding to title C may be associated with a column of table data corresponding to the cell 1011 corresponding to title A.

The update setting interface 102 may include a start-stop setting item 1024, for example, in the form of an automatic update identification field and a switch button displayed. For example, sliding to the right to turn on the automatic update mode, and sliding to the left to turn off the automatic update mode.

The update setting interface 102 may further include a control display region 1025. A preview control, a cancel control, and a determine control can be displayed in the control display region 1025. The preview control may be configured to view update preview data obtained by updating at least a part of the first table data based on the update setting information in the update setting interface 102. The cancel control may be configured to cancel the update setting operation in the update setting interface 102. The determine control may be configured to save the update setting operation in the update setting interface 102, so as to apply the update setting information to the table data corresponding to the title.

According to the technical solution of the embodiment of the present disclosure, by displaying an update setting interface in response to an update setting request for the first table data, visual setting of update information of the first table data is supported, and because the update setting interface includes a start-stop configuration item, and the start-stop configuration item is configured to configure a start-stop state of the automatic update mode of the first table data, a customized setting of the start-stop state of the automatic update mode of the first table data is supported. Then, the start-stop configuration operation for the start-stop configuration item is received through the update setting interface, and the start-stop state of the automatic update mode of the first table data is determined according to the start-stop configuration operation, which not only supports the automatic update of the first table data, but also can conveniently and flexibly set the automatic update mode of the first table data to an enabled state or a disabled state through a simple interactive operation, thereby solving the technical problem of low table update efficiency caused by manually updating cells one by one in related technologies, simplifying the update operation of the table data, improving the update efficiency of the table data, and improving the use experience of the table.

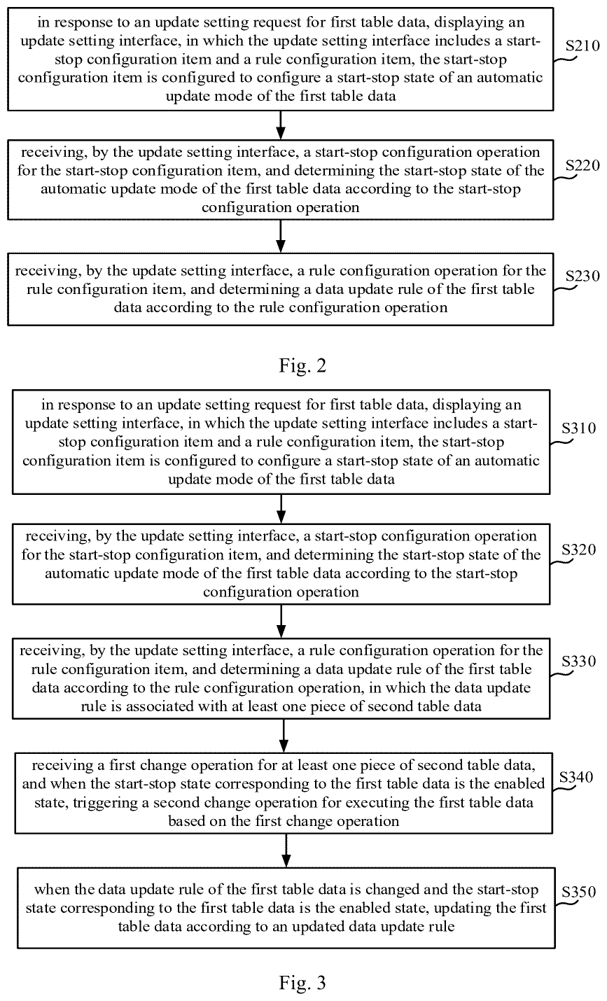

FIG. 2 is a schematic flow diagram of another data processing method provided by an embodiment of the present disclosure. In the technical solution of this embodiment, on the basis of the above embodiment, the update configuration for the first table data is further refined. Optionally, after displaying the update setting interface, the data processing method further includes: receiving, by the update setting interface, a rule configuration operation for the rule configuration item, and determining a data update rule of the first table data according to the rule configuration operation. For detailed implementation, please refer to the description of this embodiment. Technical features that are the same or similar to those of the foregoing embodiments will not be described herein. As shown in FIG. 2, the method of this embodiment may specifically include:

S210, in response to an update setting request for first table data, displaying an update setting interface, in which the update setting interface includes a start-stop configuration item and a rule configuration item, the start-stop configuration item is configured to configure a start-stop state of an automatic update mode of the first table data.

S220: receiving, by the update setting interface, a start-stop configuration operation for the start-stop configuration item, and determining the start-stop state of the automatic update mode of the first table data according to the start-stop configuration operation.

S230: receiving, by the update setting interface, a rule configuration operation for the rule configuration item, and determining a data update rule of the first table data according to the rule configuration operation.

As described above, the rule configuration item is configured to configure the data update rule of the first table data. In other words, the rule configuration item may be understood as an information item for configuring a generation rule of the first table data. That is, the generation rule of the first table data may be configured by the rule configuration item. Exemplarily, the rule configuration operation may be at least one selected from a group of a rule addition operation, a rule deletion operation, a rule modification operation on the rule configuration item, and combinations thereof.

The data update rule may be understood as a rule followed by the first table data during the update. The data update mode may be understood as a mode adopted for data updating of the first table data, such as an automatic update mode or a manual update mode. The data generation method may be understood as a generation method of updated data of the first table data, and may be obtained by processing based on a preset data arithmetic logic or generated based on data generation model, for example. The data update rule may be related to table data other than the first table data, or may be a rule not related to table data other than the first table data.

By displaying the rule configuration item in the update setting interface, and receiving the rule configuration performed on demand for the rule configuration item, a data update rule of the first table data can be determined according to the configured rule information.

According to the technical solution of the embodiment of the present disclosure, by setting the rule configuration item in the update setting interface, the configurable information of the update setting interface is enriched, the rule configuration operation for the rule configuration item can be received through the update setting interface, and the data update rule of the first table data is determined according to the rule configuration operation, so that visual configuration for the data update rule is realized, and the operation method is simple, the flexibility and convenience of configuring the data update rule are increased, and the configuration experience for the data update rule is improved.

FIG. 3 is a schematic flow diagram of another data processing method provided by an embodiment of the present disclosure. In the technical solution of this embodiment, on the basis of the above-described embodiment, a scenario in which the data update rule is associated with at least one piece of second table data is further refined. Optionally, after determining the start-stop state of the automatic update mode of the first table data according to the start-stop configuration operation, the data processing method further includes: receiving a first change operation for at least one piece of second table data, and when the start-stop state corresponding to the first table data is the enabled state, triggering a second change operation for executing the first table data based on the first change operation. And/or, when the data update rule of the first table data is changed and the start-stop state corresponding to the first table data is the enabled state, updating the first table data according to an updated data update rule. For detailed implementation, please refer to the description of this embodiment. Technical features that are the same or similar to those of the foregoing embodiments will not be described herein. As shown in FIG. 3, the method of this embodiment may specifically include:

S310, in response to an update setting request for first table data, displaying an update setting interface, in which the update setting interface includes a start-stop configuration item and a rule configuration item, the start-stop configuration item is configured to configure a start-stop state of an automatic update mode of the first table data.

S320: receiving, by the update setting interface, a start-stop configuration operation for the start-stop configuration item, and determining the start-stop state of the automatic update mode of the first table data according to the start-stop configuration operation.

S330: receiving, by the update setting interface, a rule configuration operation for the rule configuration item, and determining a data update rule of the first table data according to the rule configuration operation, in which the data update rule is associated with at least one piece of second table data.

The second table data may be understood as table data other than the first table data in the target table. It should be noted that, in an embodiment of the present disclosure, the data update rule of the first table data may be associated with the second table data, or may not be associated with the second table data. The data update rule is associated with at least one piece of second table data, and it can be understood that the change data of the first table data is associated with the second table data. That is, when the second table data is changed, the first table data may be changed.

S340: receiving a first change operation for at least one piece of second table data, and when the start-stop state corresponding to the first table data is the enabled state, triggering a second change operation for executing the first table data based on the first change operation.

As can be seen from the foregoing content, the start-stop state corresponding to the first table data is an enabled state, which indicates that the automatic update mode is turned on for the change of the first table data, and the first table data can be automatically updated when the change trigger condition of the first table data is reached. In this case, the first change operation for the second table data associated with the first table data is received, and the second table data is data that is needed to be considered in the data update rule of the first table data, and at this time, the first table data is updated according to the second table data and the data update rule, that is, the second change operation is triggered to execute the first table data. In short, when the automatic update mode is turned on for the first table data, the change of the second table data may trigger the update of the first table data. The first change operation may be at least one selected from a group of a data addition operation (an operation of adding second table data, for example, an operation of adding second table data to a blank cell), a data deletion operation (an operation of deleting second table data), a data modification operation (an operation of modifying second table data), and combinations thereof.

As an optional implementation of the embodiments of the present disclosure, optionally, after triggering the second change operation for executing the first table data based on the first change operation, the data processing method further includes: displaying change progress information corresponding to the first table data. The advantage of adopting this technical solution is that, the update progress of the first table data can be visually displayed, the execution status of the second change operation can be fully understood, and the initiator of the first change operation can be helpful to know the approximate execution time of the second change operation.

The change progress information is configured to indicate an execution progress of the change of the first table data. Optionally, the change progress information may be associated with a change time of the first table data (an execution time of the second change operation), or may be associated with a change time of the first table data.

Further, when the change progress information is associated with the change time of the first table data, the change progress information may be configured to indicate at least one piece of information selected from a group of: total duration spent on the change of the first table data that has been changed, total duration estimated on the change of the first table data that has not been changed (still needed to be changed), and a ratio of total duration spent on the change of changed first table data to total duration estimated on the change of all the first table data that need to be changed, and combinations thereof.

Similarly, the change progress information is associated with the number of changes of the first table data, which may be that, the change progress information is associated with at least one selected from a group of: the total number of pieces of the first table data that has been changed, the total number of pieces of the first table data that has not been changed, and combination thereof. Further, the change progress information can be configured to indicate a ratio of a total number of pieces of the changed first table data to a total number of all pieces of the first table data needed to be changed. Alternatively, the change progress information may be configured to indicate a total number of pieces of remaining first table data that has been changed, a total number of pieces of the first table data that has not been changed (still needed to be changed), or the like. The total number of pieces of the first table data that has not been changed (still needed to be changed) can be obtained by differentiating the total number of all pieces of the first table data needed to be changed from the total number of pieces of the first table data that has been changed.

In an embodiment of the present disclosure, the execution time of the second change operation is associated with attribute information of an initiator of the first change operation. According to this technical solution, execution time of the second change operations triggered by initiators of different attribute information can be effectively distinguished, which is suitable for, for example, a case where it is necessary to respond to second change operations triggered by a plurality of initiators, and execution pressure of the second change operation can be effectively balanced, and the second change operation can be ensured to be executed orderly and smoothly.

Optionally, the execution time of the second change operation may be time at which the execution of the second change operation is started, or time taken from the start of the execution of the second change operation to the completion of the execution of the second change operation. Specifically, the execution time of the second change operation may be determined according to attribute information of the initiator of the first change operation. Specifically, a response priority corresponding to the initiator may be determined according to the attribute information of the initiator of the first change operation, and the execution time of the second change operation may be determined according to the response priority. The attribute information of the initiator may include at least one selected from a group of type information corresponding to the initiator, identification information of the initiator, and combination thereof, and the like.

S350: when the data update rule of the first table data is changed and the start-stop state corresponding to the first table data is the enabled state, updating the first table data according to an updated data update rule.

As described above, the start-stop state corresponding to the first table data is an enabled state, which indicates that the automatic update mode is turned on for the change of the first table data, and the first table data can be automatically updated in the case where the change trigger condition of the first table data is reached. In this case, second table data associated with the first table data is in the target table, and the second table data is data to be considered in the data update rule of the first table data, and in this time, when the data update rule is changed, the first table data is changed according to the updated data update rule.

It should be noted that, the updated data update rule may be associated with the second table data, for example, an association rule corresponding to the second table data may be changed, or associated third table data (table data other than the first table data and the second table data) may be added. The updated data update rule may no longer be associated with the second table data. For example, the updated data update rule may be a fixed numerical value, or may be associated with the third table data, or the like. At this time, updating the first table data according to the updated data update rule may be, filling the first table data with a fixed numerical value, or updating the first table data according to the third table data and the data updating rule.

According to the technical solution of the embodiment of the present disclosure, in the case where the data update rule is associated with at least one piece of second table data, the first table data may be updated according to the updated data update rule when the data update rule of the first table data is changed and the start-stop state corresponding to the first table data is the enabled state, that is, the first table data can be updated in the case where the data update rule changes; and by receiving a first change operation for at least one piece of second table data, and when the start-stop state corresponding to the first table data is the enabled state, triggering a second change operation for executing the first table data based on the first change operation, the first table data can be automatically updated according to the change of the second table data, thereby changing the first table data in a timely manner when the automatic update mode of the first table data is turned on, and sufficiently ensuring the accuracy of the first table data.

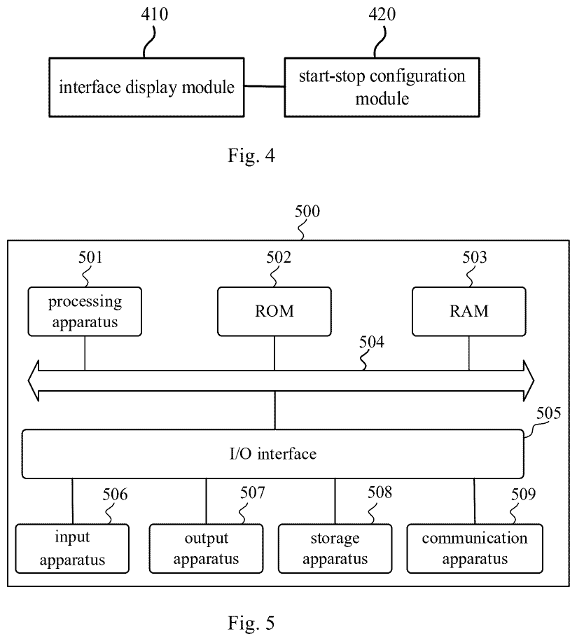

FIG. 4 is a schematic structural diagram of a data processing apparatus provided by an embodiment of the present disclosure. As shown in FIG. 4, the data processing apparatus includes a n interface display module 410 and a start-stop configuration module 420. The interface display module 410 is configured to display an update setting interface in response to an update setting request for first table data, the update setting interface includes a start-stop configuration item, the start-stop configuration item is configured to configure a start-stop state of an automatic update mode of the first table data, the start-stop state includes an enabled state and a disabled state; the start-stop configuration module 420 is configured to receive, by the update setting interface, a start-stop configuration operation for the start-stop configuration item, and determine the start-stop state of the automatic update mode of the first table data according to the start-stop configuration operation.

According to the technical solution of the embodiment of the present disclosure, the interface display module 410 displays an update setting interface in response to an update setting request for the first table data, and supports visual setting of update information of the first table data, and because the update setting interface includes a start-stop configuration item, and the start-stop configuration item is configured to configure a start-stop state of the automatic update mode of the first table data, a customized setting of the start-stop state of the automatic update mode of the first table data is supported. Then, the start-stop configuration module 420 receives the start-stop configuration operation for the start-stop configuration item through the update setting interface, determines the start-stop state of the automatic update mode of the first table data according to the start-stop configuration operation, which not only supports the automatic update of the first table data, but also can conveniently and flexibly set the automatic update mode of the first table data to an enabled state or a disabled state through a simple interactive operation, thereby solving the technical problem of low table update efficiency caused by manually updating cells one by one in related technologies, simplifying the update operation of the table data, improving the update efficiency of the table data, and improving the use experience of the table.

On the basis of any of the above optional technical solutions, optionally, the update setting interface includes a rule configuration item. Further, the data processing apparatus may further include a rule configuration module. The rule configuration module is configured to, after displaying the update setting interface, receive, by the update setting interface, a rule configuration operation for the rule configuration item, and determine a data update rule of the first table data according to the rule configuration operation.

On the basis of any of the above optional technical solutions, optionally, the data update rule is associated with at least one piece of second table data. Further, the data processing apparatus may further include a data trigger change module. The data trigger change module is configured to, after determining the start-stop state of the automatic update mode of the first table data according to the start-stop configuration operation, receive a first change operation for at least one piece of second table data, and when the start-stop state corresponding to the first table data is the enabled state, trigger a second change operation for executing the first table data based on the first change operation.

On the basis of any of the above optional technical solutions, optionally, the data processing apparatus may further include a change progress display module. The change progress display module is configured to, after triggering the second change operation for executing the first table data based on the first change operation, display change progress information corresponding to the first table data.

On the basis of any of the above optional technical solutions, optionally, the change progress information is associated with a total number of pieces of second table data that is needed to be changed, and at least one selected from a group of: a total number of pieces of second table data that has been changed, a total number of pieces of second table data that has not been changed, and combination thereof.

On the basis of any of the above optional technical solutions, optionally, execution time of the second change operation is associated with attribute information of an initiator of the first change operation.

On the basis of any of the above optional technical solutions, optionally, the data update rule is associated with at least one piece of second table data. Further, the data processing apparatus may further include a rule trigger change module. The rule trigger change module is configured to, after determining the data update rule of the first table data according to the rule configuration operation, and when the data update rule of the first table data is changed and the start-stop state corresponding to the first table data is the enabled state, update the first table data according to an updated data update rule.

On the basis of any of the above optional technical solutions, optionally, the rule configuration item includes a model configuration item; the model configuration item is configured to configure model associated information corresponding to an adopted data generation model; the model associated information includes a data generation method, model input information, and model output information.

On the basis of any of the above optional technical solutions, optionally, the update setting interface further includes an update preview control. Further, the data processing apparatus further includes an update preview module. The update preview module is configured to, after displaying the update setting interface, when a plurality of pieces of first table data that the start-stop configuration operation acts, display update preview data in at least a partial number of the plurality of pieces of first table data in response to a control trigger operation for the update preview control.

The data processing apparatus provided by the embodiment of the present disclosure can execute the data processing method provided by any embodiment of the present disclosure, and has corresponding functional modules and beneficial effects for executing the data processing method.

It is worth noting that each unit and module included in the above apparatus is only divided according to functional logic, but it is not limited to the above division, as long as the corresponding functions can be realized; in addition, the specific names of each functional unit are only for the convenience of distinguishing each other, and are not used to limit the protection scope of the embodiment of the present disclosure.

FIG. 5 is a schematic structural diagram of an electronic device provided by an embodiment of the present disclosure. Referring to FIG. 5 below, which shows a schematic structural diagram of an electronic device (such as the terminal device or server in FIG. 5) 500 suitable for implementing an embodiment of the present disclosure. A terminal device in the embodiment of the present disclosure may include but not limited to a mobile terminal such as a mobile phone, a notebook computer, a digital radio broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device shown in FIG. 5 is only an example and should not impose any limitations on the functions and usage scopes of the embodiments of the present disclosure.

As shown in FIG. 5, the electronic device 500 may include a processing apparatus (such as a central processing unit, a graphics processor, and the like) 501, which may execute various appropriate actions and processes according to a program stored in a read-only memory (ROM) 502 or a program loaded from a storage apparatus 508 to a random-access memory (RAM) 503. In the RAM 503, various programs and data needed for operations of the electronic device 500 are further stored. The processing apparatus 501, the ROM 502, and the RAM 503 are connected to each other by a bus 504. An input/output (I/O) interface 505 is also connected to the bus 504.

Generally, the following apparatuses may be connected to the I/O interface 505: an input apparatus 506 such as a touch screen, a touch pad, a keyboard, a mouse, a camera, a microphone, an accelerometer, a gyroscope, etc.; an output apparatus 507 such as a liquid crystal display (LCD), a loudspeaker, a vibrator, etc.; a storage apparatus 508 such as a magnetic tape, and a hard disk, etc.; and a communication apparatus 509.The communication apparatus 509 may allow the electronic device 500 to perform wireless or wire communication with other devices to exchange data. Although FIG. 5 shows the electronic device 500 with various apparatuses, it should be understood that it is not needed to implement or possess all the apparatuses shown. It may implement alternatively or possess the more or less apparatuses.

According to the embodiment of the present disclosure, the process described above with reference to the flowcharts may be achieved as a computer software program. For example, an embodiment of the present disclosure includes a computer program product, the computer program product includes a computer program loaded on a non-transitory computer-readable medium, and the computer program contains program codes for executing the method shown in the flowcharts. In such an embodiment, the computer program may be downloaded and installed from the network by the communication apparatus 509, or installed from the storage apparatus 508, or installed from ROM 502. When the computer program is executed by the processing apparatus 501, the above functions in the method in the embodiments of the present disclosure are executed.

The names of messages or information exchanged between a plurality of apparatus in the embodiment of the present disclosure are only used for illustrative purposes, and are not used to limit the scope of these messages or information.

The electronic device provided by the embodiment of the present disclosure belongs to the same inventive concept as the data processing method provided by the above embodiment. For technical details not described in detail in the present embodiment, please refer to the above embodiment, and the present embodiment has the same beneficial effects as the above embodiment.

An embodiment of the present disclosure provides a computer storage medium, on which a computer program is stored, which, when executed by a processor, realizes the data processing method provided in the above embodiment.

It should be noted that the computer-readable medium mentioned above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, device or device, or any combination thereof. More specific examples of the computer-readable storage medium may include, but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, device or device. In the present disclosure, the computer-readable signal medium may include a data signal propagated in a baseband or as a part of a carrier wave, in which computer-readable program codes are carried. This propagated data signal may take multiple forms, including but not limited to an electromagnetic signal, an optical signal or any suitable combination of the above. The computer-readable signal medium may also be any computer-readable medium other than the computer-readable storage medium, and may send, propagate or transmit a program used by or in combination with an instruction execution system, device or device. The program codes contained on the computer-readable medium may be transmitted by any suitable medium, including but not limited to: an electric wire, a fiber-optic cable, radio frequency (RF) and the like, or any suitable combination of the above.

In some implementation methods, a client and the server can communicate by using any currently known or future developed network protocol such as a hypertext transfer protocol (HTTP), and may communicate and interconnect with digital data in any form or medium (for example, a communication network). Examples of the communication network include a local area network (“LAN”), a wide area network (“WAN”), the Internet work (for example, the Internet) and an end-to-end network (for example, an ad hoc end-to-end network), as well as any currently known or to be researched and developed in the future.

The above computer-readable medium may be contained in the above electronic device; and it may also exist separately without being assembled into the server.

The above computer-readable medium carries one or more programs, and when the above one or more programs are executed by the electronic device, the electronic device is caused to: in response to an update setting request for first table data, display an update setting interface, in which the update setting interface includes a start-stop configuration item, the start-stop configuration item is configured to configure a start-stop state of an automatic update mode of the first table data, the start-stop state includes an enabled state and a disabled state; and receive, by the update setting interface, a start-stop configuration operation for the start-stop configuration item, and determine the start-stop state of the automatic update mode of the first table data according to the start-stop configuration operation.

Computer program codes for performing the operations of the present disclosure may be written in one or more programming languages or a combination thereof, the programming languages include, but are not limited to, object-oriented programming languages such as Java, Smalltalk and C++, and further include conventional procedural programming languages such as “C” programming language or similar programming languages. The program codes may be entirely executed on a user's computer, partially executed on the user's computer, executed as an independent software package, partially executed on the user's computer and partially executed on a remote computer, or entirely executed on the remote computer or a server. In the case involving the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, function and operation of possible implementations of the systems, methods and the computer program product according to various embodiments of the present disclosure. In this regard, each block in the flowcharts or block diagrams may represent a module, a program segment, or a part of codes, which includes one or more executable instructions for implementing specified logical functions. It should also be noted that, in some alternative implementations, the functions noted in the blocks may occur out of the order noted in the accompanying drawings. For example, two blocks illustrated in succession may, in fact, be executed substantially in parallel, and may sometimes be executed in a reverse order, depending on the function involved. It should also be noted that, each block in the block diagrams and/or flowcharts, and combinations of blocks in the block diagrams and/or flow diagrams, may be implemented by a dedicated hardware-based system that performs specified functions or operations, or by a combination of dedicated hardware and computer instructions.

The involved units described in the embodiments of the present disclosure may be implemented by a mode of software, or may be implemented by a mode of hardware. Herein, the name of the unit does not constitute a limitation on the unit itself in a certain situation. For example, the interface display module may also be described as “a module that requests display of an update setting interface”.

The functions described above in this article may be at least partially executed by one or more hardware logic components. For example, non-restrictively, exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a tangible medium that may include or store a program used by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, device or device, or any suitable combination of the above. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, example 1 provides a data processing method, includes: in response to an update setting request for first table data, displaying an update setting interface, in which the update setting interface includes a start-stop configuration item, the start-stop configuration item is configured to configure a start-stop state of an automatic update mode of the first table data, the start-stop state includes an enabled state and a disabled state; receiving, by the update setting interface, a start-stop configuration operation for the start-stop configuration item, and determining the start-stop state of the automatic update mode of the first table data according to the start-stop configuration operation.

According to one or more embodiments of the present disclosure, example 2 provides the method of example 1, optionally, the update setting interface includes a rule configuration item; after displaying the update setting interface, further includes: receiving, by the update setting interface, a rule configuration operation for the rule configuration item, and determining a data update rule of the first table data according to the rule configuration operation.

According to one or more embodiments of the present disclosure, example 3 provides the method of example 2, optionally, the data update rule is associated with at least one piece of second table data; after determining the start-stop state of the automatic update mode of the first table data according to the start-stop configuration operation, further includes: receiving a first change operation for at least one piece of second table data, and when the start-stop state corresponding to the first table data is the enabled state, triggering a second change operation for executing the first table data based on the first change operation.

According to one or more embodiments of the present disclosure, example 4 provides the method of example 3, optionally, after triggering the second change operation for executing the first table data based on the first change operation, further includes: displaying change progress information corresponding to the first table data.

According to one or more embodiments of the present disclosure, example 5 provides the method of example 4, further includes: optionally, the change progress information is associated with a total number of pieces of second table data that is needed to be changed, and at least one selected from a group of: a total number of pieces of second table data that has been changed, a total number of pieces of second table data that has not been changed, and combination thereof.

According to one or more embodiments of the present disclosure, example 6 provides the method of example 3, further includes: optionally, execution time of the second change operation is associated with attribute information of an initiator of the first change operation.

According to one or more embodiments of the present disclosure, example 7 provides the method of example 2, optionally, the data update rule is associated with at least one piece of second table data; after determining the data update rule of the first table data according to the rule configuration operation, further includes: when the data update rule of the first table data is changed and the start-stop state corresponding to the first table data is the enabled state, updating the first table data according to an updated data update rule.

According to one or more embodiments of the present disclosure, example 8 provides the method of example 2, further includes: optionally, the rule configuration item includes a model configuration item; the model configuration item is configured to configure model associated information corresponding to an adopted data generation model; the model associated information includes a data generation method, model input information, and model output information.

According to one or more embodiments of the present disclosure, example 9 provides the method of example 1, optionally, the update setting interface further includes an update preview control, and after displaying the update setting interface, further includes: when a plurality of pieces of first table data that the start-stop configuration operation acts, displaying update preview data in at least a partial number of the plurality of pieces of first table data in response to a control trigger operation for the update preview control.

According to one or more embodiments of the present disclosure, example 10 provides a data processing apparatus, which includes: an interface display module, configured to display an update setting interface in response to an update setting request for first table data, in which the update setting interface includes a start-stop configuration item, the start-stop configuration item is configured to configure a start-stop state of an automatic update mode of the first table data, the start-stop state includes an enabled state and a disabled state; a start-stop configuration module, configured to receive, by the update setting interface, a start-stop configuration operation for the start-stop configuration item, and determine the start-stop state of the automatic update mode of the first table data according to the start-stop configuration operation.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

Furthermore, although various operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A data processing method, comprising:
in response to an update setting request for first table data, displaying an update setting interface, wherein the update setting interface comprises a start-stop configuration item, the start-stop configuration item is configured to configure a start-stop state of an automatic update mode of the first table data, the start-stop state comprises an enabled state and a disabled state;
receiving, by the update setting interface, a start-stop configuration operation for the start-stop configuration item, and determining the start-stop state of the automatic update mode of the first table data according to the start-stop configuration operation.

2. The data processing method according to claim 1, wherein the update setting interface comprises a rule configuration item; after displaying the update setting interface, the data processing method further comprises:
receiving, by the update setting interface, a rule configuration operation for the rule configuration item, and determining a data update rule of the first table data according to the rule configuration operation.

3. The data processing method according to claim 2, wherein the data update rule is associated with at least one piece of second table data; after determining the start-stop state of the automatic update mode of the first table data according to the start-stop configuration operation, the data processing method further comprises:
receiving a first change operation for at least one piece of second table data, and when the start-stop state corresponding to the first table data is the enabled state, triggering a second change operation for executing the first table data based on the first change operation.

4. The data processing method according to claim 3, wherein after triggering the second change operation for executing the first table data based on the first change operation, the data processing method further comprises:
displaying change progress information corresponding to the first table data.

5. The data processing method according to claim 4, wherein the change progress information is associated with a total number of pieces of second table data that is needed to be changed and at least one selected from a group of: a total number of pieces of second table data that has been changed, a total number of pieces of second table data that has not been changed, and combination thereof.

6. The data processing method according to claim 3, wherein execution time of the second change operation is associated with attribute information of an initiator of the first change operation.

7. The data processing method according to claim 2, wherein the data update rule is associated with at least one piece of second table data; after determining the data update rule of the first table data according to the rule configuration operation, the data processing method further comprises:
when the data update rule of the first table data is changed and the start-stop state corresponding to the first table data is the enabled state, updating the first table data according to an updated data update rule.

8. The data processing method according to claim 2, wherein the rule configuration item comprises a model configuration item; the model configuration item is configured to configure model associated information corresponding to an adopted data generation model; the model associated information comprises a data generation method, model input information, and model output information.

9. The data processing method according to claim 1, wherein the update setting interface further comprises an update preview control, and after displaying the update setting interface, the data processing method further comprises:
when a plurality of pieces of first table data that the start-stop configuration operation acts, displaying update preview data in at least a partial number of the plurality of pieces of first table data in response to a control trigger operation for the update preview control.

10. An electronic device, comprising:
one or more processors;
a storage apparatus, configured to store one or more programs,
wherein in response to that the one or more programs are executed by the one or more processors, the one or more processors are caused to implement a data processing method, which comprises:
in response to an update setting request for first table data, displaying an update setting interface, wherein the update setting interface comprises a start-stop configuration item, the start-stop configuration item is configured to configure a start-stop state of an automatic update mode of the first table data, the start-stop state comprises an enabled state and a disabled state;
receiving, by the update setting interface, a start-stop configuration operation for the start-stop configuration item, and determining the start-stop state of the automatic update mode of the first table data according to the start-stop configuration operation.

11. The electronic device according to claim 10, wherein the update setting interface comprises a rule configuration item; after displaying the update setting interface, the data processing method further comprises:
receiving, by the update setting interface, a rule configuration operation for the rule configuration item, and determining a data update rule of the first table data according to the rule configuration operation.

12. The electronic device according to claim 11, wherein the data update rule is associated with at least one piece of second table data; after determining the start-stop state of the automatic update mode of the first table data according to the start-stop configuration operation, the data processing method further comprises:
receiving a first change operation for at least one piece of second table data, and when the start-stop state corresponding to the first table data is the enabled state, triggering a second change operation for executing the first table data based on the first change operation.

13. The electronic device according to claim 12, wherein after triggering the second change operation for executing the first table data based on the first change operation, the data processing method further comprises:
displaying change progress information corresponding to the first table data.

14. The electronic device according to claim 13, wherein the change progress information is associated with a total number of pieces of second table data that is needed to be changed, and at least one selected from a group of: a total number of pieces of second table data that has been changed, a total number of pieces of second table data that has not been changed, and combination thereof.

15. The electronic device according to claim 12, wherein execution time of the second change operation is associated with attribute information of an initiator of the first change operation.

16. The electronic device according to claim 11, wherein the data update rule is associated with at least one piece of second table data; after determining the data update rule of the first table data according to the rule configuration operation, the data processing method further comprises:
when the data update rule of the first table data is changed and the start-stop state corresponding to the first table data is the enabled state, updating the first table data according to an updated data update rule.

17. The electronic device according to claim 11, wherein the rule configuration item comprises a model configuration item; the model configuration item is configured to configure model associated information corresponding to an adopted data generation model; the model associated information comprises a data generation method, model input information, and model output information.

18. The electronic device according to claim 10, wherein the update setting interface further comprises an update preview control, and after displaying the update setting interface, the data processing method further comprises:
when a plurality of pieces of first table data that the start-stop configuration operation acts, displaying update preview data in at least a partial number of the plurality of pieces of first table data in response to a control trigger operation for the update preview control.

19. A non-transitory storage medium, comprising a computer-executable instruction, wherein the computer-executable instruction, in response to being executed by a computer processor, is configured to execute a data processing method, which comprises:
in response to an update setting request for first table data, displaying an update setting interface, wherein the update setting interface comprises a start-stop configuration item, the start-stop configuration item is configured to configure a start-stop state of an automatic update mode of the first table data, the start-stop state comprises an enabled state and a disabled state;
receiving, by the update setting interface, a start-stop configuration operation for the start-stop configuration item, and determining the start-stop state of the automatic update mode of the first table data according to the start-stop configuration operation.

20. The non-transitory storage medium according to claim 19, wherein the update setting interface comprises a rule configuration item; after displaying the update setting interface, the data processing method further comprises:
receiving, by the update setting interface, a rule configuration operation for the rule configuration item, and determining a data update rule of the first table data according to the rule configuration operation.
